(19) United States
(12) Patent Application Publication
(10) Pub. No.: US 2008/0312947 A1
(43) Pub. Date: Dec. 18, 2008

(54) METHOD OF IDENTIFYING ANIMALS WITH LIKELIHOOD OF PROVIDING HIGH QUALITY MEAT

(75) Inventors: Richard P. Cronce, Brattleboro, VT (US); John M. Meyer, Brattleboro, VT (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: HOLSTEIN ASSOCIATION, USA, INC., Brattleboro, VT (US)

(21) Appl. No.: 12/135,505

(22) Filed: Jun. 9, 2008

Related U.S. Application Data
(60) Provisional application No. 60/943,369, filed on Jun. 12, 2007.

(51) Int. Cl. G06Q 50/00; G06F 17/30; A01K 11/00

(52) U.S. Cl. 705/1

(57) ABSTRACT

A method of identifying prior to or after birth whether an animal, such as a Holstein calf, has an acceptable likelihood of producing high quality meat comprises the steps of:
providing a unique identification indicia for the animal; providing, to a central organization, detailed information about the animal including at least some of the lineage of the animal, the provided information being keyed to the unique identification indicia of the animal; entering the detailed information for the animal into a central organization database keyed to the unique identification indicia for the animal; calculating a conditional probability percentage that the animal will provide high quality meat based on genetic information of at least one member of the lineage of the animal which is obtained from the central organization database; and selecting the animal for a particular raising program if the conditional probability percentage for the animal is greater than or equal to a predetermined limit.

### CROSS REFERENCE TO RELATED APPLICATIONS

This application claims the priority of U.S. Provisional Patent Application No. 60/943,369 filed Jun. 12, 2007 and entitled “Method of Identifying Animals with Likelihood of Providing High Quality Meat”, the subject matter of which is hereby incorporated herein by reference.

### BACKGROUND OF THE INVENTION

The present invention relates to meat quality and, in particular, to a method of identifying animals, preferably before, at or near the time of their birth, which have a predetermined likelihood of providing high quality meat.

In the meat industry, it is well known that high quality meat, such as “prime” beef, generally commands the highest market price and provides for greater profitability than lower quality meat, such as “utility” beef. There are a variety of techniques that have been used within the meat industry to try to improve the quality of meat. Such techniques include everything from feeding the animals special diets (i.e. corn fed), subjecting the animals to little or no exercises or to special exercises, injecting the animals with substances such as hormones, steroids or the like, and others. While some such techniques have achieved limited success, other such techniques, particularly the injection techniques, have proven to be too controversial and have been used only in limited situations or have been abandoned. None of the known techniques have been shown to consistently provide high quality meat under all circumstances.

More recently it has been determined that there is a link between the DNA of an animal and the quality of the meat which is produced from the animal. Several quantitative loci (QTL) or genetic markers have been identified for various meat traits. For example, in the case of beef, GeneSTAR genetic marker panels (distributed in the United States by BoviGen Corp.) have been consistently associated with an improvement in fat marbling and quality grade of beef. Each of the genetic markers in the panels has been found by independent validation and testing of beef carcasses across multiple breeds of cattle to be highly associated with increased fat marbling and higher quality grades. Similarly, also in the case of beef, Igenity Corp. has identified a genetic marker panel that is also associated with high quality grades of beef. Cattle that do not have the positive forms of these genes have been found to produce tougher beef.

While genetic testing of each individual animal at or shortly after birth could be useful in determining which animals will provide the best quality meat, such individual genetic testing is not practical primarily due to the cost of performing such testing and the large number of animals born each year. For example, the current lowest cost for performing a genetic test on a calf is about $20.00-$45.00 per head, depending on the service and the number of traits or markers tested. Since there are over four million male Holstein calves born each year, performing a separate genetic test, even on only each male Holstein calf is prohibitively expensive.

The present invention is a method of using limited genetic testing which has previously been performed on animals, such as cattle, with the results being maintained in a database, along with performing genetic statistical projections using the information from the database to establish a conditional probability of the likelihood that a particular calf will later yield high quality beef. In this manner, calves which are identified as having a conditional probability of providing high quality beef which is at or above a predetermined minimum probability can be raised in a manner that will be likely to improve the likelihood that the resulting beef will be tender and of high quality.

### BRIEF SUMMARY OF THE INVENTION

Briefly stated, the present invention, in one embodiment, comprises a method of identifying prior to or after birth whether an animal has an acceptable likelihood of producing high quality meat. The method comprises the steps of: providing a unique identification indicia for the animal; providing, to a central organization, detailed information about the animal including at least some of the lineage of the animal, the provided information being keyed to the unique identification indicia of the animal; entering the detailed information for the animal into a central organization database keyed to the unique identification indicia for the animal; calculating a conditional probability percentage that the animal will provide high quality meat based on genetic information of at least one member of the lineage of the animal which is obtained from the central organization database; and selecting the animal for a particular raising program if the conditional probability percentage for the animal is greater than or equal to a predetermined limit.

In another embodiment the present invention comprises a method of identifying prior to or after birth whether a Holstein calf has an acceptable likelihood of producing high quality beef comprising the steps of: providing a unique identification indicia for the Holstein calf; providing, to a central organization, detailed information about the Holstein calf including at least some of the lineage of the calf, the provided information being keyed to the unique identification indicia of the calf; entering the detailed information for the calf into a central organization database keyed to the unique identification indicia for the calf; calculating a conditional probability percentage that the calf will provide high quality beef based on genetic information of at least one member of the lineage of the calf which is obtained from the central organization database; and selecting the calf for a particular raising program if the conditional probability percentage for the calf is greater than or equal to a predetermined limit.

### BRIEF DESCRIPTION OF THE SEVERAL VIEWS OF THE DRAWING

The following detailed description of preferred embodiments of the invention will be better understood when read in conjunction with the appended drawing. For the purpose of illustrating the invention, there is shown in the drawing an embodiment which is presently preferred. It should be understood, however, that the invention is not limited to the precise arrangements and instrumentalities shown.

In the drawing:

FIG. 1 is a functional flow diagram illustrating the steps of a preferred method of identifying whether a Holstein calf has a conditional probability of providing tender, high quality grade beef in accordance with the present invention.

### DETAILED DESCRIPTION OF THE INVENTION

Certain terminology is used in the following description for convenience only and is not limiting. The words “right,” “left,” “lower” and “upper” designate directions in the drawing to which reference is made. Unless specifically set forth herein, the terms “a”, “an” and “the” are not limited to one element but instead should be read as meaning “at least one”. The terminology includes the words noted above, derivatives thereof and words of similar import. In addition, in this document the term “calf” shall refer to a born or unborn animal.

The present invention comprised a method of identifying animals, preferably at or near birth, which have a high likelihood of providing tender, high quality grade meat using the results of genetic testing of lineage animals and genetic statistical projections or conditional probability analysis. The detailed description set forth below focuses on the application of the method of the present invention to a particular breed of cattle and, more particularly, to Holstein cattle. It should be clearly understood that the present invention is not limited to Holstein cattle but is equally applicable to other breeds of cattle such as Angus, for example. Additionally, although the below described detailed embodiment relates to Holstein cattle, the invention is also applicable to other animals, such as hogs or pigs, birds, such as poultry or fowl, fish or other living food sources which have DNA which includes one or more genetic markers or panels of genetic markers which have been shown to have a relationship to fat marbling, tenderness, quality, feed efficiency or other desirable features of the resulting meat or food. Further, although in the below described embodiment the presence of one or more specified DNA or genetic markers or genetic panels are identified as being associated with tenderness or quality grade in beef obtained from Holstein cattle, it will be appreciated by those skilled in the art that the present invention is not limited to a particular genetic marker or panel of genetic markers and that one or more different genetic markers or genetic marker panels may be used in other applications.

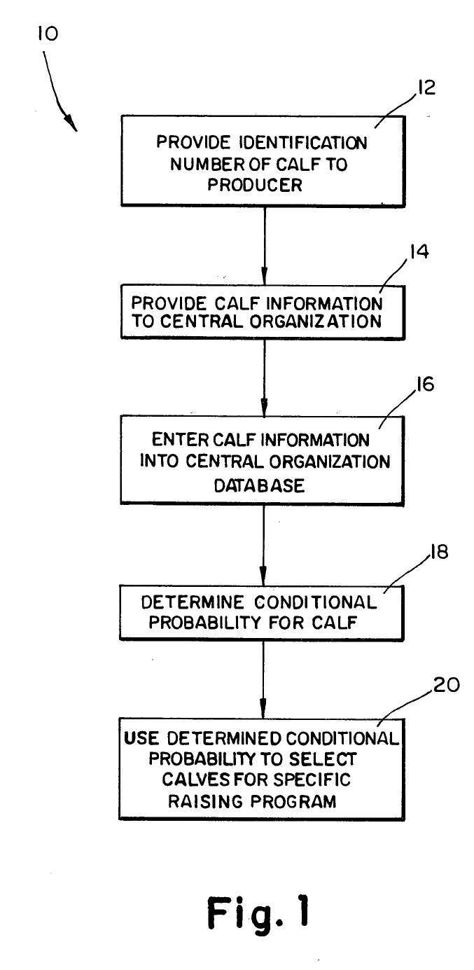

Referring to the flow diagram of FIG. 1, in practicing the method 10 of the present invention the first step 12 is to provide accurate, positive and permanent identification for each new born or soon to be born Holstein calf. Prior to, at or within a few days from birth, each participating Holstein calf is positively identified by the owner or other producer, preferably using a unique identification device, such as a radio frequency identification device or RFID animal ear tag or the like permanently secured to the calf after birth. The RFID ear tag includes an integrated circuit or chip having a nonvolatile memory which includes a unique, multiple character identification indicia which is assigned or supplied by a centralized data collection and processing organization (“central organization”) such as the Holstein Association USA. The unique identification indicia could include a multi digit number, a string of characters, a combination of numbers and characters or anything else that will uniquely identify the particular animal. Preferably a unique identification number is used, however the use of a number should not be considered to be a limitation on the present invention and it should be clearly understood that any form or unique permanent identification could be used. In the present embodiment, the unique identification number stored in the RFID tag is used to associate the calf with certain information throughout the life of the calf which is thereafter provided by the producer and others to the central organization for storage and processing as described below. When an RFID tag is interrogated with the proper radio frequency, the RFID tag retrieves the unique identification number (or indicia) from the nonvolatile memory and outputs the retrieved identification number to a receiver (usually associated with the interrogator) where the unique number is captured and read to positively identify the calf. Other types of ear tags or other permanent identification devices which provide a unique identification number or other indicia for the calf may alternatively be employed. All calves participating in the program of the present method are required to adhere to specified quality control standards from birth until slaughter. For example, preferably a participating calf must be fed the proper colostrums preferably beginning immediately after birth and continuing at least until the calf is transported from the premises of the producer.

The next step 14 in practicing the present method is for the producer to provide to the central organization detailed information about the calf to which the RFID tag has been or after birth will be secured. The information provided by the producer includes a confirmation of the unique identification number assigned to the calf along with at least all available information concerning the lineage of the calf including the identity of at least one of the sire and the dam and preferably both. Other information, such as the date and place of birth of the calf and producer contact information, birth statistics, secondary identification information and the like may also be provided but is not required. The unique identification number is thereafter periodically used to provide additional information to the central organization throughout the life of the calf and thereafter. For example, when the calf is transferred to a calf raising facility in accordance with a scheduled timeframe, that calf raising facility transmits information to the central organization confirming the date of arrival along with other relevant information such as the weight of the calf. Dietary, medical and other information concerning the raising of the calf may also be periodically provided to the central organization. Similarly, when the calf is slaughtered, that information is supplied to the central organization along with information about the carcass, including at least the beef quality grade information.

The central organization, in the case of Holstein calves the Holstein Organization USA, serves as a data repository and maintains an active database which currently includes detailed information on over twenty two million Holstein animals. In the next step 16 of the present method, all of the information received by the central organization with respect to an RFID tagged or otherwise identified Holstein calf is entered into the central organization database keyed to the unique identification number of the calf. In this manner, all of the details about the lineage and current status of the calf (i.e. in a calf raising facility, at a feed lot, etc.) are continuously up to date for all participating animals throughout the entire life cycle of each animal.

Usually, a calf can be easily associated with its dam, but association with its sire may be more difficult. DNA testing can be performed after the birth of the calf to identify the sire if needed. The central organization performs blood type and DNA tests on all newly registered or identified Holstein bulls to assure parentage and for determining whether a new bull exhibits any or all of the DNA markers or genetic marker panels which are identified with tender or higher grade beef. Additionally, the central organization determines from the received information the currently most active sires (the ones with the most offspring) and any of them which have not previously been tested are DNA tested. As a result, the database of the central organization contains DNA information, specifically information regarding the relevant DNA markers and marker panels associated with tenderness and higher quality grade for Holstein beef for most, if not all Holstein bulls which could potentially be in the lineage of a particular Holstein calf, in some cases going back for several generations or more.

Any DNA markers associated with tenderness and higher quality grade beef can be used in embodiments of the present invention. For example, the DNA markers can include, but are not limited to, any of those commercially available DNA markers associated with marbling or tenderness of meats.

In one embodiment, a method of the present invention involves one or more DNA markers in the GeneSTAR® Quality Grade marker panel, which comprises a C/T SNP in the consensus binding sequence for RNA polymerase III, 537 bp upstream from the start of the first exon of thyroglobulin (TG5, position 422 of GenBank accession #X05380; Barendse et al., 2004, Aust. J. Exp. Agric. 44:669-674) and an anonymous single nucleotide polymorphism (SNP) (QG2). In one particular embodiment, the present method involves the currently available GeneSTAR® Quality Grade marker panel, which includes four major genes associated with quality grade and marbling, QG1 (TG5), QG2 (M2), QG3, and QG4.

In another embodiment, a method of the present invention involves one or more markers in the GeneSTAR® Tenderness panel, which comprises a G/A SNP in the 3′ untranslated region of calpastatin (CAST-T1, base 2959 of GenBank accession #AF159246; Barendse, 2002, WO 02/064820 A1), a G/C SNP in exon 9 of μ-calpain (CAPNI 316-T2, base 5709 of GenBank accession #AF252504; Page et al., 2002, J. Anim. Sci. 80:3077-3085), and a C/T SNP in the intron between the 17th and 18th exon of μ-calpain (CAPNI 4751-T3, base 6545 of GenBank accession #AF248054; White et al., 2005, J. Anim. Sci. 83:2001-2008). In one particular embodiment, the present method involves the currently available GeneSTAR® Tenderness marker panel, which includes four markers within two important genes calpastatin and calpain.

In yet another embodiment, a method of the present invention involves one or more markers in the Igenity Tender-GENE marker panel, which comprises the two μ-calpain SNP described above in the Gene-STAR Tenderness panel, and a calpastatin SNP (UoG-CAST, a G/C SNP in the intronic sequence between exons 5 and 6 of calpastatin, base 282 of GenBank accession #AY008267); Schenkel et al., 2006, J. Anim. Sci. 84:291-299). In one particular embodiment, the present method involves the currently available Igenity Tender-GENE marker panel, which includes three markers within two important genes calpastatin and calpain.

The Gene-STAR Tenderness panel and the Igenity Tender-GENE marker panel share two common μ-calpain SNPs. Each panel also has a calpastatin SNP, which reside at different loci of the calpastatin gene. It is believed that the combination of the calpain and calpastatain genes act to break down muscle fibers in cattle, thereby naturally tenderizing the resulting meat. Accordingly, DNA markers associated with tenderness and higher quality grade beef can include one or more other DNA markers within the calpain and calpastatain genes.

DNA testing of any marker associated with tenderness and higher quality grade beef can be performed using methods known to those skilled in the art in view of the present disclosure. For example, DNA markers can be identified by analyzing DNA samples collected from hair, tissue, blood, or semen samples. In one embodiment of the present invention, DNA testing can be performed by companies that commercialize the marker or marker panels.

The next step 18 in the present method is for the central organization to determine the conditional probability that a particular calf possesses the necessary DNA markers or genetic panels associated with tenderness, palatability and higher quality grades (“prime” or “choice”) for the beef carcass which will eventually be obtained from the fully grown calf. This step may be performed before or after the birth of a calf. The determination of conditional probability is made by first accessing the database to determine the lineage of the calf and whether the sire, dam and/or other animals in the lineage of the calf actually possess or possessed the relevant DNA markers. For example, if both the sire and dam for a particular calf have all of the relevant DNA markers then, because of genetics, the conditional probability that the calf will also possess all of the relevant markers is very high, at or near 100%. As noted above, the DNA marker information available in the database of the central organization primarily relates to bulls. As a result, the database may not contain DNA marker information regarding the dam of a particular calf. In such cases, the conditional probability determination may be made using just the DNA marker information of the sire of the calf. Alternatively, the conditional probability determination may be made using the DNA marker information of the sire as well as the sire of the dam (maternal grandfather) of the calf. For example, if the database confirms that the sire possesses all of the relevant DNA markers and no DNA information is available in the database about the dam or her lineage, the conditional probability that the calf will possess the relevant DNA markers is about 50%. Likewise, if the database confirms that the sire possesses all of the relevant DNA markers and the sire of the dam (maternal grandfather) of the calf also possesses all of the relevant DNA markers then the conditional probability that the calf will possess the relevant DNA markers is about 75%. A simple formula is used to make the determination. The probability that the sire possesses all of the relevant DNA markers (100% if the sire has been tested) is added with the probability that the dam contains all of the relevant DNA markers and the result is averaged (divided by two) to provide the conditional probability that the calf will also possess all of the relevant DNA markers. Once the conditional probability has been determined a percentage number is associated with the calf and the percentage number is entered into the database. It has been found that the determined conditional probability number is correct on average but that the actual values (established by actual DNA testing of the animal) may vary. Using the database at the central organization the determination of the conditional probability may take into consideration the lineage of a calf as far back as the DNA information is available.

The relevant DNA markers that are used in making the above described determination may vary in certain applications. For example, in some applications only a single DNA marker, such as the GeneSTAR TG5 marker which is associated with an enzyme that creates fat cells within muscle fibers as energy stores for increased marbling may be used by itself. In other applications, two or more markers or the entire GeneSTAR panel, i.e. all four of the above-identified markers, may be used since the four marker panel is widely used in the beef industry for culling out of both males and females which do not possess the markers. In other applications one or more or all three of the above-discussed Igenity markers may be used. Further, in some applications a combination of one or more GeneSTAR markers and one or more Igenity markers may be used. Regardless of the particular DNA marker or markers which are used the conditional probability determination for a particular calf is made to establish a percentage number for the calf which is stored in the central organization database as discussed above.

Once the conditional probability percentage number has been determined for a calf that percentage number is used to decide whether the calf should or should not be placed into a particular program designed to enhance the likelihood that the calf will provide tender, high quality grade beef. If the conditional probability percentage is at or above a predetermined limit, the likelihood that the calf will produce high quality grade beef in said to be acceptable and the calf may be placed into the program. At the present time, the predetermined limit for an acceptable likelihood that a calf will produce high quality grade beef is set at twenty-five percent (25%). However, it will be appreciated by those skilled in the art that the predetermined limit may be greater or less than twenty-five percent based on several factors including but not limited to the success of the program in producing sufficiently high quality grade beef using the twenty-five percent limit. As actual carcass information is provided for each animal, a relationship between the animal's previously determined conditional probability to produce high quality grade beef is compared to the actual grade of the beef from the carcass. For example, if experience demonstrates that too many calves placed into the program which have a conditional probability percentage number which is at or near the twenty-five percent limit do not provide beef at the desired quality grade, then the predetermined limit may be increased, for example to thirty percent or higher. Correspondingly, if experience demonstrates that a high number of calves placed into the program which have a conditional probability percentage number which is at or near the twenty-five percent limit do provide beef at the desired quality grade, then the predetermined limit may be decreased, for example to twenty percent or lower. Accordingly it should be clearly understood that the predetermined limit of the conditional probability for selection of a particular calf for the program may vary from time to time.

Beef quality can be measured using methods well known to those skilled in the art. For example, tenderness can be evaluated through the use of any known test and should not be considered a limitation on the present invention.

Calves having a conditional probability at or above the predetermined limit and, as a result, are selected for the program may be separated from other calves shortly after birth and receive special treatment for the remainder of their lives. Such calves which are selected for the program are sent to specified calf raising facilities where they are given special diets and are otherwise treated in a manner designed to enhance their chances of providing the desired high quality grade beef. Likewise, calves which are selected for the program are later sent to specified feedlots where they are also given special diets and are otherwise treated in a manner designed to enhance their chances of providing the desired high quality grade beef. Some of the calves selected for the program may be subjected to additional special processing. For example, some calves may be given a special diet consistent with the creation of “natural products” for enhanced marketability. Other special features can be applied to calves selected for the program depending on market demands and requirements. As noted above, information on each such calf is provided to the central organization at each stage of its life so the database can be constantly updated. When a selected calf is slaughtered all carcass trait information is also provided to the central organization to update the database. The central organization continuously monitors and analyzes the database to confirm the correctness of the previously determined conditional probabilities for each selected calf to thereby enhance the predictions and selection process in the future. Beef produced from selected calves and which have the requisite tenderness and high quality grade may be entitled to be marketed under a special trademark to inform the buying public of the consistent high quality of the beef.

Calves which are not selected for the program may be raised in a conventional manner and the resulting beef may be marketed in a conventional manner. Additionally, the central organization database provides the ability to deal with cloned calves or calves having cloning in their lineage. Such calves which may or may not be selected for the program depending on preferences or marketing requirements. For example, producers who want to keep only natural cattle will have such calves excluded from their program.

It will be appreciated by those skilled in the art that changes could be made to the embodiment described above without departing from the broad inventive concepts thereof. It is understood, therefore, that this invention is not limited to the particular embodiment disclosed, but it is intended to cover all modifications within the spirit and scope of the invention as defined by the appended claims.

1. A method of identifying prior to or after birth whether a Holstein calf has an acceptable likelihood of producing high quality beef comprising the steps of:
providing a unique identification indicia for the Holstein calf;
providing, to a central organization, detailed information about the Holstein calf including at least some of the lineage of the calf, the provided information being keyed to the unique identification indicia of the calf;
entering the detailed information for the calf into a central organization database keyed to the unique identification indicia for the calf;
calculating a conditional probability percentage that the calf will provide high quality beef based on genetic information of at least one member of the lineage of the calf which is obtained from the central organization database; and
selecting the calf for a particular raising program if the conditional probability percentage for the calf is greater than or equal to a predetermined limit.

2. The method of claim 1 wherein the central organization database contains genetic information about at least the sire of the calf.

3. The method of claim 1 wherein the genetic information in the central organization database includes at least one genetic marker of the sire of the calf, the at least one genetic marker relating to at least one of fat marbling, tenderness and beef quality grade.

4. The method of claim 1 wherein the predetermined limit is twenty-five percent.

5. The method of claim 1 further comprising the step of periodically providing to the central organization and entering into the central organization database detailed information about the calf over the lifetime of the calf.

6. The method of claim 1 further including the step of providing to the central organization and entering into the central organization database detailed carcass information after the slaughtering of the calf including at least the actual quality grade of the beef obtained from the calf.

7. A method of identifying prior to or after birth whether an animal has an acceptable likelihood of producing high quality meat comprising the steps of:
providing a unique identification indicia for the animal;
providing, to a central organization, detailed information about the animal including at least some of the lineage of the animal, the provided information being keyed to the unique identification indicia of the animal;
entering the detailed information for the animal into a central organization database keyed to the unique identification indicia for the animal;
calculating a conditional probability percentage that the animal will provide high quality meat based on genetic information of at least one member of the lineage of the animal which is obtained from the central organization database; and
selecting the animal for a particular raising program if the conditional probability percentage for the animal is greater than or equal to a predetermined limit.

8. The method of claim 7 wherein the central organization database contains genetic information about at least the sire of the animal.

9. The method of claim 7 wherein the genetic information in the central organization database includes at least one genetic marker of the sire of the animal, the at least one genetic marker relating to at least one of fat marbling, tenderness and meat quality grade.

10. The method of claim 7 wherein the predetermined limit is twenty-five percent.

11. The method of claim 7 further comprising the step of periodically providing to the central organization and entering into the central organization database detailed information about the animal over the lifetime of the animal.

12. The method of claim 7 further including the step of providing to the central organization and entering into the central organization database detailed carcass information after the slaughtering of the animal including at least the actual quality grade of the meat obtained from the animal.
